(19) United States
(12) Patent Application Publication
(10) Pub. No.: US 2007/0030963 A1
(43) Pub. Date: Feb. 8, 2007

(54) Securing and controlling access to digital data

(75) Inventors: Jeremy Wyld, San Jose, CA (US); Timothy E. Wasko, High River (CA); Greg Marriott, Palo Alto, CA (US); Stanley C. Ng, Campbell, CA (US)

Correspondence Address: BEYER WEAVER & THOMAS, LLP, P.O. BOX 70250, OAKLAND, CA, 94612-0250, US

(73) Assignee: Apple Computer, Inc.

(21) Appl. No.: 11/198,087

(22) Filed: Aug. 4, 2005

(51) Int. Cl. H04L 9/00

(52) U.S. Cl. 380/44

(57) ABSTRACT

Techniques for securing and controlling access to digital data are disclosed. A security-code is generated based on a plurality of input received from an input device which does not have to be a keyboard (e.g., joy-stick, sensor, touch-screen), but can detect movement input by a user. The movement can, for example, be received as rotational movement to emulate a mechanical combination lock which is familiar and easy to use. Digital data is secured by a security code generated in response to movement (e.g., rotational movement) which can be conveniently entered by users. Users can conveniently reenter the security-code by input movement in order to access secured digital data.

### BACKGROUND OF THE INVENTION

Today, information can be stored as digital data and presented in numerous forms including audible, visual, or audio-visual forms. Digital data can also be transported electronically, for example, as digital files or digital streams. Basically speaking, digital data can be stored in or as a “digital media” (e.g., a digital file, a media-player which stores digital data). Digital data can be accessed, for example, by a variety of computing devices available today (e.g., personal computers, media-players, personal assistants, wireless phones). Typically, digital media includes at least digital content (or “content”) that represents that actual content of information stored in a digital form. As such, digital content can, for example, be the content of a printed book, a song in audible form and/or in audio-visual forms (e.g., a rock video), movies, sports broadcasts, news in a variety of forms including text, audio, or audio-visual.

Broadly speaking, a “digital media asset” (“or digital asset”) as used herein refers, for example, to digital data itself (e.g., a digital file), or a medium used to store and/or access digital data (e.g., a media-player), or an access mechanism associated with accessing digital data (e.g., a menu or executable program used to access digital data, and/or present digital data (e.g., play a song, display a movie). As such, examples of a “digital media asset” include, but are not in any way limited to: a digital item (e.g., a digital file), a collection of single digital items (e.g., a list of digital files that may have been grouped together), and a mechanism used to power-on or access digital data (e.g., menu, button, or other mechanism associated with accessing or presenting digital data. It should also be noted that in addition to content, digital media can also include “metadata” (or data about the content). Metadata can, for example, include information about the format used to store digital data, rights and permissions, usage history, etc.

With ever increasing popularity and use of digital data, securing digital data has become a major concern. Accordingly, security techniques for securing digital media would be highly useful and valuable to various entities that typically have procured digital asset at a significant cost. These entities, for example, range from an individual who has purchased a single digital item (e.g., a song, or a picture) to a corporation that has spent millions of dollars to store data crucial to operation of the corporation (e.g., medical records, financial accounts) in a digital form.

### SUMMARY OF THE INVENTION

Broadly speaking, the invention relates to securing and controlling access to digital data. In accordance with one aspect of the invention, security techniques for securing digital data are disclosed. Digital data may, for example, be stored in or as digital media, or in or as a digital media asset (or media asset). As will be described in greater detail below, a security-code can be generated from input and used to secure a digital data. Typically, the security-code is generated based on a plurality of input which can, for example, be received from the same input device. The plurality of input can, for example, be associated with input received from an end-user (e.g., a human). It will be appreciated that the input device does not have to be a keyboard. As for example, in one embodiment, the plurality of input is received as movement via an input device (e.g., joy-stick, sensor, touch-screen) that can detect movement input by a user.

In accordance with another embodiment, the movement may, for example, be received as rotational movement (e.g., left or right rotational movement) input by a human via an input device (e.g., touch-screen) provided by or connected to a computing device (e.g., personal computer, mobile media-player). The rotational movement can, for example, be used to generate one or more security-keys (e.g., numbers) that can effectively represent a security-code used to secure digital data (e.g., a digital media asset). In other words, the user may enter a security-code by inputting left or right rotational movement. In accordance with yet another embodiment of the invention, a virtual combination-lock which can effectively simulate a mechanical combination-lock can be provided. Similar to a mechanical combination lock which is divided into several numbers (e.g., 0-35) and can be used to secure a physical asset (e.g., locker, gate) by a “combination” (e.g., 35R, 8L, 12L), the user may rotate a virtual circle (or wheel) by inputting left or right rotational movement and selecting various security-keys that are displayed.

Broadly Speaking, a security-code generated from a plurality of movement may, for example, be used to secure digital data (e.g., digital content itself), and/or secure access to digital data and/or medium used to store digital data, and/or mechanisms used to access and/or present digital data. Those skilled in the art will appreciate that digital data can be secured by a variety of techniques, for example, by encrypting digital data (e.g., content), or by locking access to digital data and/or medium and/or mechanisms used to store, access, or present digital data.

Other aspects of the invention provides techniques for controlling access to digital data. Generally, access can be controlled based on a code which is required to be entered (“input-code”) in order to access digital data. The input-code can, for example, be used to decrypt digital content data (e.g., content) and/or unlock access to digital data and/or medium user to store digital data and/or mechanisms used to store, access, or present digital data.

It will also be appreciated by those skilled in the art that the invention can be implemented in numerous ways, including as a method, an apparatus, a computer readable medium, a database product, program, or system. Several embodiments of the invention are discussed below.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, wherein like reference numerals designate like structural elements, and in which:

FIG. 1A depicts a computing system capable of securing a digital media asset in accordance with one embodiment of the invention.

FIG. 1B depicts a computing system capable of controlling access to a secured digital media asset in accordance with one embodiment of the invention.

FIG. 2A depicts a security method for securing a digital media asset in accordance with one embodiment of the invention.

FIG. 2B depicts a controlling-access method for controlling access to a digital media asset.

FIG. 3A-3B depict a computing system in accordance with one embodiment of the invention.

FIG. 3C depicts a security method for securing a digital media asset in accordance with one embodiment of the invention.

FIG. 3D depicts a method for controlling access to a digital media asset in accordance with one embodiment of the invention.

FIG. 4A-4C depict a virtual circle with three (3) security-keys denoted as A, B and C.

FIG. 5A-5F depicts a computing system in accordance with one embodiment of the invention.

FIG. 6 depicts a method for generating a security-code from rotational movement received by input device from a user in accordance with one embodiment of the invention.

FIG. 7A depicts a plurality of virtual circles arranged to present a security code in accordance with one embodiment of the invention.

FIG. 7B depicts a computing device in accordance with one embodiment of the invention.

### DETAILED DESCRIPTION OF THE INVENTION

As noted above, securing digital data is an important concern. Conventionally, a keyboard is used to enter a string of characters which collectively represent a “password” used to secure access, for example, to a file or a personal computer. Conventional techniques for securing digital data are useful. However, it is not always possible or desirable to provide a keyboard for a device. Furthermore, when a keyboard is provided or emulated, typing a password has proved to be especially problematic for users of mobile devices (e.g., wireless phones, personal digital assistants, media-players). Hence, there is need for alterative techniques for securing digital data.

Accordingly, the invention provides techniques for securing and controlling access to digital data. In accordance with one aspect of the invention, security techniques for securing digital data are disclosed. Digital data may, for example, be stored in or as digital media, or in or as a digital media asset (or media asset). As will be described in greater detail below, a security-code can be generated from input and used to secure a digital data. Typically, the security-code is generated based on a plurality of input which can, for example, be received from the same input device. The plurality of input can, for example, be associated with input received from an end-user (e.g., a human). It will be appreciated that the input device does not have to be a keyboard. As for example, in one embodiment, the plurality of input is received as movement via an input device (e.g., joy-stick, sensor, touch-screen) that can detect movement input by a user.

In accordance with another embodiment, the movement may, for example, be received as rotational movement (e.g., left or right rotational movement) input by a human via an input device (e.g., touch-screen) provided by or connected to a computing device (e.g., personal computer, mobile media-player). The rotational movement can, for example, be used to generate one or more security-keys (e.g., numbers) that can effectively represent a security-code used to secure digital data (e.g., a digital media asset). In other words, the user may enter a security-code by inputting left or right rotational movement. In accordance with yet another embodiment of the invention, a virtual combination-lock which can effectively simulate a mechanical combination-lock can be provided. Similar to a mechanical combination lock which is divided into several numbers (e.g., 0-35) and can be used to secure a physical asset (e.g., locker, gate) by a “combination” (e.g., 35R, 8L, 12L), the user may rotate a virtual circle (or wheel) by inputting left or right rotational movement and selecting various security-keys that are displayed.

Broadly Speaking, a security-code generated from a plurality of movement may, for example, be used to secure digital data (e.g., digital content itself, and/or secure access to digital data and/or medium used to store digital data, and/or mechanisms used to access and/or present digital data. Those skilled in the art will appreciate that digital data can be secured by a variety of techniques, for example, by encrypting digital data (e.g., content), or by locking access to digital data and/or medium and/or mechanisms used to store, access, or present digital data.

Other aspects of the invention provides techniques for controlling access to digital data. Generally, access can be controlled based on a code which is required to be entered (“input-code”) in order to access digital data. The input-code can, for example, be used to decrypt digital content data (e.g., content) and/or unlock access to digital data and/or medium user to store digital data and/or mechanisms used to store, access, or present digital data.

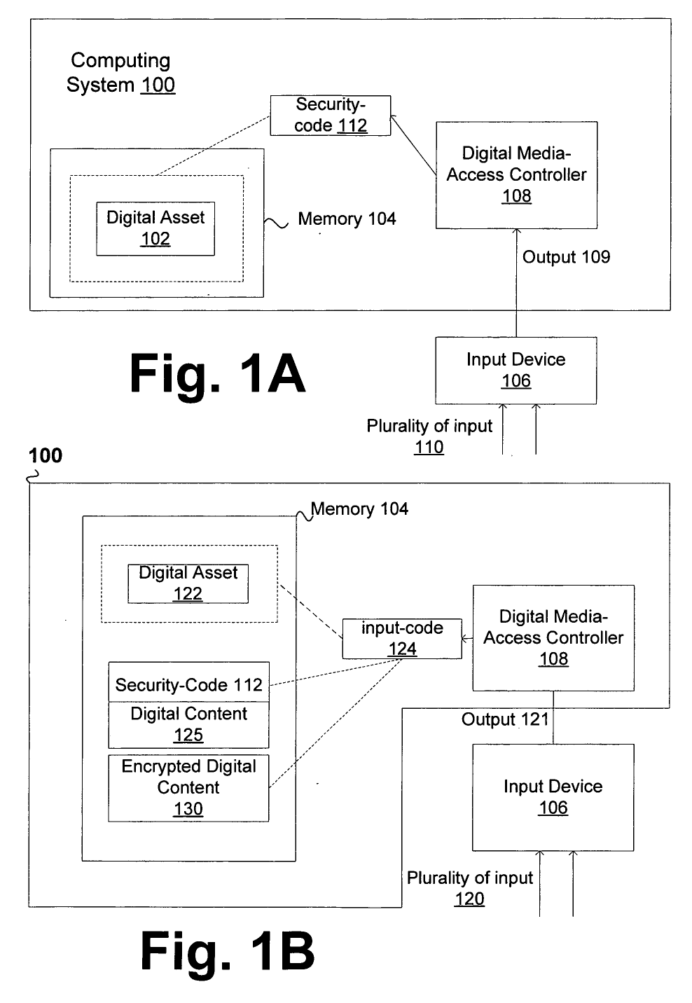

Embodiments of these aspects of the invention are discussed below with reference to FIGS. 1A-7B. However, those skilled in the art will readily appreciate that the detailed description given herein with respect to these figures is for explanatory purposes as the invention extends beyond these limited embodiments.

FIG. 1A depicts a computing system 100 capable of securing a digital media asset (or digital asset) 102 in accordance with one embodiment of the invention. As shown in FIG. 1A, the computing system 100 includes memory 104 and a digital media-access controller 108. It will be appreciated that the digital media-access controller 108 can generate a security-code 112 based on output 109 received from an input device 106. Typically, output 109 is associated with a plurality of input 110 received by the input device 106 and transmitted as output 109 to the digital media access controller 108. As will be described in greater detail below, the security-code 112 can be used to secure the digital media asset 102. It should be noted that the digital media asset 102 may be stored in memory 104 prior to application of the security-code 112 or it may be stored after it has been secured by the security-code 112. In any case, access to the digital asset 102 can be secured by the security-code 112. As will be described below, access to the digital asset 102 may be secured, for example, by using the security-code 112 as an access-lock (or lock), or a key used to encrypt digital data associated with digital-asset 102. In general, the security-code 112 secures the digital-asset 102.

It should be understood that digital media asset 102 can, for example, be digital data, an access mechanism to digital data, or a medium or device used to store digital data in memory. Thus, the security-code 112 can effectively secure content stored in the computing system 100 or the computing system 100 itself. Examples of digital media asset which may be secured by the security-code 112 include, a single digital item (e.g., audio song), a collection of digital items (e.g., list of audio songs), a menu, a program, a device, or a media player. It should also be noted that the input device 106 need not be a keyboard. In one embodiment, the digital media-access controller 108 is capable of generating the security-code 112 based on, for example, movement (e.g., rotational movement) from or associated with a user (e.g., end-user, human) input.

As will be known to those skilled in the art, the digital media-access controller 108 may be implemented as software and/or hardware. The computing system 100 may also include at least one processor configured to access memory 104 (not shown) and/or the input device 106 which may be provided as a part of the computing system 100. The computing system 100 can, for example, be a personal computer, a laptop computer, a wireless phone, a media player, or a personal digital assistant. As the following examples demonstrate, the security-code 112 may be stored in memory 104 (e.g., saved as a header for a digital asset), but the security-code 112 does not have to be stored in memory (e.g., used to encrypt/decrypt the digital asset 102).

In accordance with another aspect of the invention, the digital media access controller 108 can control access to secured digital data (e.g., a digital media asset). The process of controlling access to a secured digital media asset is described with reference to FIG. 1B in accordance with one embodiment of the invention. Initially, the digital media access controller 108 determines whether to control access to a digital asset 122. A determination whether to control access to the digital asset 122 can, for example, be made when the digital media access controller 108 detects that there is an explicit or implicit request to access the digital media asset 122, but the digital media asset 122 has been secured by a security-code 112 (e.g., locked and/or encrypted).

An explicit request to access can, for example, be initiated from, the input device 106 or another computing system linked to the computing system 100. Alternatively, the media access controller 108 may automatically determine that it needs to secure access to the digital media asset 122. By way of example, when the computing system 100 is powered on, the media-access controller 108 may automatically initiate controlling access to digital data stored in memory 104. In any case, access to the secured digital media asset 122 can be controlled partly based on an input-code 124 that is generated based on output 121 received from the input device 106.

More particularly, when the digital media-access controller 108 determines to control access to the digital asset 122, it can subsequently generate an input-code 124 from output 121 represents a plurality of input 120 received by the input device 106. Typically, the input-code 124 is entered by a user who. is attempting to access the digital asset 122. Subsequently, the digital media-access controller 108 uses the input-code 124 to control access to the digital media asset 122. As will be appreciated by those skilled in the art, the input-code 124 may, for example, be applied to unlock and/or decrypt the digital asset 122. By way of example, the input-code 124 may be compared to the security-code 112 which has been stored, for example, as a header for the digital content 125. As another example, the input-code 124 may, for example, be used to decrypt an encrypted digital content 130 which has been encrypted using a security-code (e.g., security-code 112).

It should be noted that media access controller 108 can control access to a digital media asset which has been secured by another entity. In other words, the digital media asset 122 may have been received as a secured digital media asset and stored in memory 104. As such, the media access controller 108 may generate the input-code 124 and compare it with a stored security-code 112, or simply apply it to a secured digital media asset 122 (e.g., as a decryption key) without knowing or storing the security-code 112.

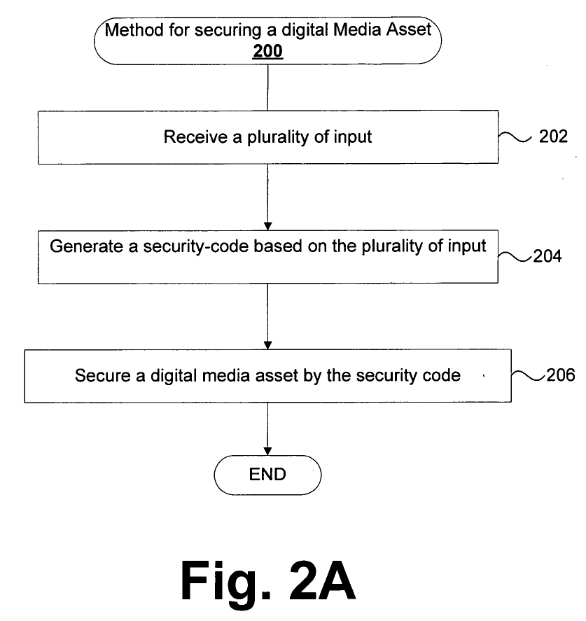

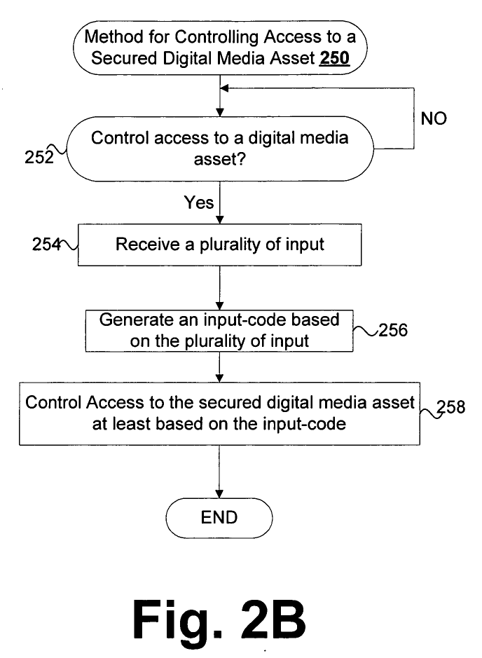

FIG. 2A depicts a security method 200 for securing a digital media asset in accordance with one embodiment of the invention. The security method 200 can, for example, be performed by the computing system 100 shown in FIG. 1A. Initially, a plurality of input is received (202). The plurality of input can, for example, be entered into an input-device and received from the input device. Next, a security-code is generated (204) based on the plurality of input. Thereafter, a digital media asset is secured (206) by the security-code generated (204), and the security method 200 ends.

FIG. 2B depicts a controlling-access method 250 for controlling access to a digital media asset. The controlling access method 250 may, for example, be performed by the computing system 100 shown in FIG. 1B. Initially, it is determined (252) whether to control access to a digital media asset. As noted above, this determination (252) can, for example, be made based on determining whether a secured digital media asset is to be accessed (e.g., a request for accessing secured digital media asset is received, automatic determination when a device is powered-on). In any case, if it is determined (252) to control access to a digital media, a plurality of input is received (254). Subsequently, an input-code is generated (256) based on the plurality of input. Finally, access to the secured digital media asset is controlled (258) at least partly based on the input-code (256) to the digital media asset. Access can, for example, be controlled by determining whether to grant access by comparing the input-code with a security-code used to secure the secured digital media asset, and/or applying the input-code to effect the content of the digital media asset (e.g., decrypt the digital media asset).

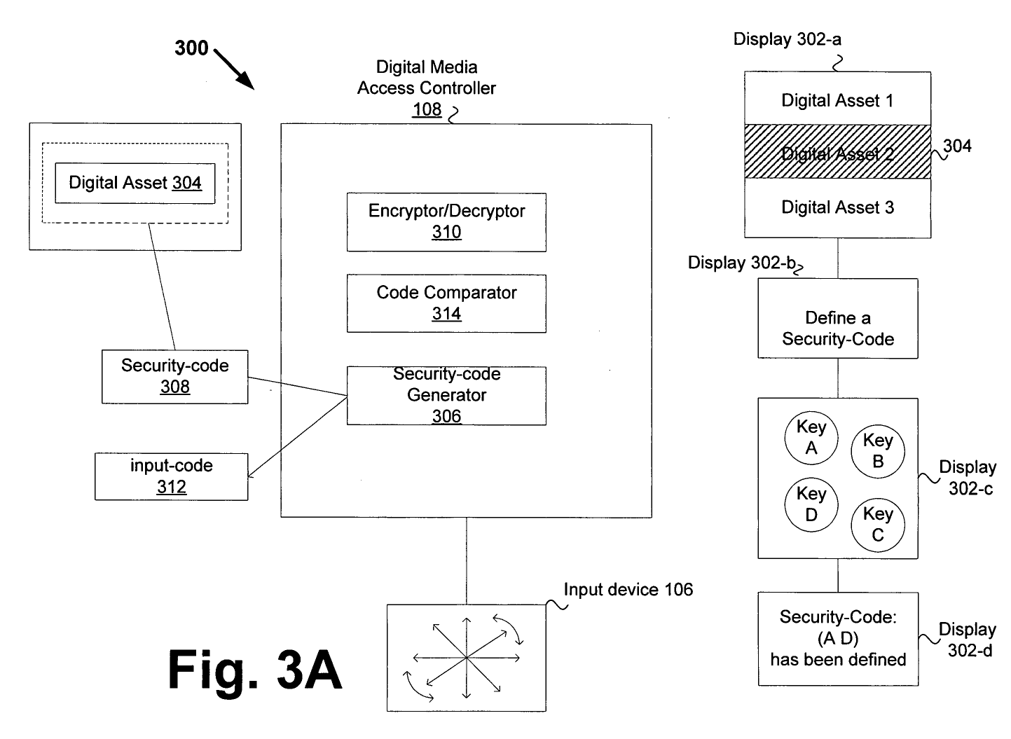

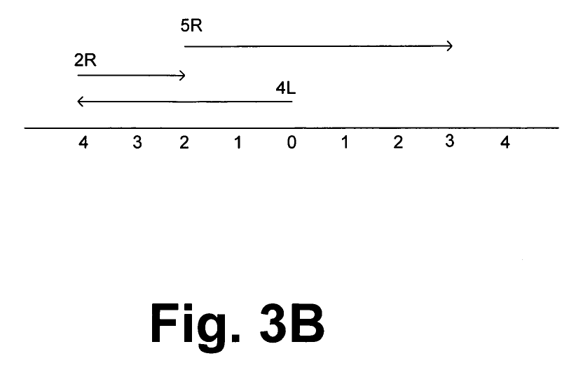

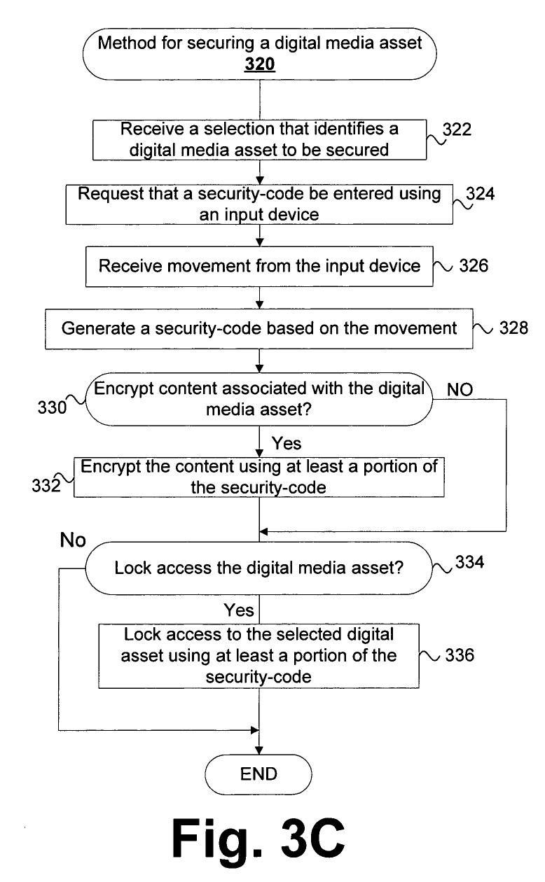

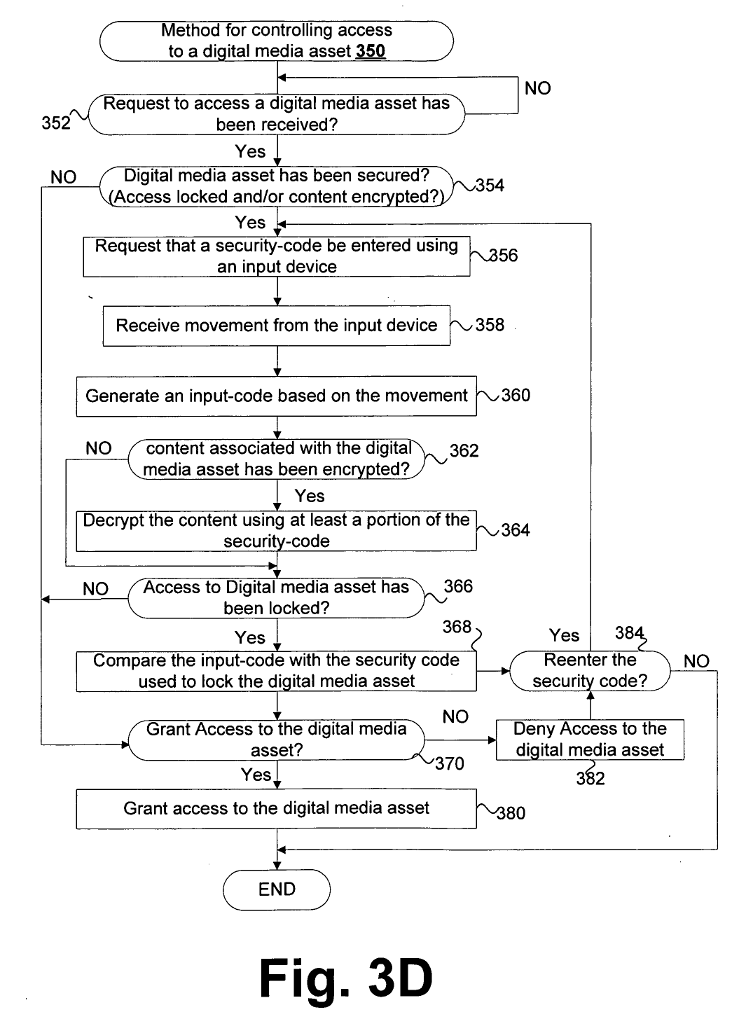

As noted above, the plurality of input may be received as movement. The following embodiment depicts a computing system which utilizes movement associated with user input. FIG. 3A depicts a digital media access controller 108 in a computing system 300 in accordance with one embodiment of the invention. The computing system 300 includes an input device 106 which receives movement as input. Typically, movement received by the input device 106 is initiated by a user, for example, by moving a finger on a touch-screen, or pressing one or more directional buttons, or moving a joy-stick. The input device 106 may also be used to interact with a graphical user interface which, among other things, can be provided to assist the user in securing a digital media asset. As such, the user is able to interact with the graphical user interface to define by a security-code which, for example, may be selected as a sequence of security-keys (e.g., number, letter, symbols). By way of example, several digital media assets (digital assets 1-3) may be displayed for the user on a display 302-a. Subsequently, the user may select a digital media asset 304 by interacting with the input device 106. In response, the user may be prompted to define (or enter) a security-code to secure the digital media asset 304 (display 302-b). The user can then enter a security-code by interacting with the input device 106. More particularly, movement initiated by the user is sensed by the input device 106 and transmitted to a security-code generator 306 which generates a security-code 308 used to secure the digital asset 304. The movement input by the user and received by the input device 106 may, for example, be directional movement (e.g., north, south, west, east, southwest, southeast) and/or rotational (e.g., left, right). As will be described in greater detail below, a plurality of security-keys may also be displayed for the user (display 302-c). This can further assist the user in defining a security-code. The user may also be able to manipulate the display 302-c and effectively control various security-keys (Key A, Key B, Key C, and Key D) that are displayed for selection. As a result, one or more security-keys can be conveniently selected by the user to effectively define a security-code. In any case, based on one or more selected security-keys, the security-code generator 306 can generate a security-code 308 which secures the digital asset 304, for example, by applying a lock or encryption. When the security-code has been defined (e.g., sequence of A-D), it can be displayed for verification by the user (302-d). It should be noted that an encrytor/decryptor 310 can use the security-code 308 to encrypt the digital asset 304 in order to secure it.

Furthermore, accessing the secured digital asset 304 would require entering an input-code 312 which is used to decrypt and/or unlock the digital asset 304. The input-code 312 can be generated based on movement received from the input device 106 in a similar manner as security-code 308 was generated (e.g., by selecting one or more security-keys displayed in display 302-c).

As shown in FIG. 3A, the digital media access controller 108 additionally include a code-comparator 314 which is used to compare the security-code 308 with an input-code 312 in order to control access to the digital media asset 304. It should be noted that movement received by the input device 106 may be represented as movement in a virtual n-dimensional space. To further elaborate, FIG. 3B depicts movement in one-dimensional space which can, for example, be a representation of user movement input into the input device 106 shown in FIG. 3A. It should be appreciated that the direction of movement may also be considered in generating a security-code. In this example, the movement is measured to be 4units to the left, then 2units to the right, and finally 5units to the right (“4L, 2R, and 5R”). As such, the movement received by the input device 106 may be transformed to a security-code that includes both direction and amount of movement in a particular direction. Those skilled in the art will readily understand that movement can be also mapped to two, three , or more generally n-dimensional virtual space (e.g., a plane, circle, cube, sphere). Furthermore, movement may be mapped to simulate physical movement used to operate, for example, a mechanical lock (e.g., rotation of one or more wheels used to open a safe or a combination lock).

FIG. 3C depicts a security method 320 for securing a digital media asset in accordance with one embodiment of the invention. The security method 320 can, for example, be used by the digital media access controller 108 shown in FIG. 3A. Initially, a selection that identifies a digital media asset which is to be secured is received (322). Next, it is requested (324) that a security-code be entered for the selected digital media asset. The security-code can be entered using an input device which receives movement as input (e.g., touch-screen, joy-stick, control-pad). Accordingly, movement from the input device is received (326) and a security-code is generated (328) based on the movement. Thereafter, it is determined (330) whether to encrypt content associated with the selected digital media asset. Accordingly, the content associated with the selected digital media content can be encrypted using at least a portion of the security-code which has been generated (328) based on the user movement received (326) from the input device. However, if it is determined (330) not to encrypt the content associated with the selected digital media asset, it is determined (334) whether to lock the digital media asset. Accordingly, the digital media asset can be locked (336) using at least a portion of the security-code, and the security method 320 ends. However, if it is determined (334) not to lock the digital media asset, the security method 320 ends, thereby bypassing the locking (336) of the access to the selected digital media asset.

It will be appreciated that determining whether to encrypt content (330) and/or lock access (334) may be made, for example, based on user input, or a defined criteria (e.g., type of digital media, list of digital media). Further as illustrated by the method 320, one or more security operations (e.g., encrypting locking access) may be performed together. However, it will be understood that it is not necessary to use these operations or other operations together. Furthermore, it is possible to replace or additionally use other security operations that use the security-code to secure a digital media asset. Generating (328) a security-code based on movement received from an input device is depicted in FIG. 6 and will be discussed further below.

However, referring now to FIG. 3D, a method 350 for controlling access to a digital media asset is depicted in accordance with one embodiment of the invention. The method 350 may, for example, be used by the digital media access controller 108 shown in FIG. 3A. Initially, it is determined 352 whether a request to access a digital media asset has been received. As noted above, this request does not have to be an explicit request for access, and can, for example, be triggered by an event (e.g., turning on a media player). In any case, if it is determined (352) that there is a request to access the digital media asset, it is determined (354) whether the digital media asset has been secured. Solely for illustration, it is assumed that the digital media asset has been secured by locking access and/or encrypting content, for example, in accordance with the security method 320 depicted in FIG. 3C. However, as noted above, it is possible to replace or additionally use other security operations that use a security-code to secure the digital media asset.

Referring back to FIG. 3D, if it is determined (354) that the digital media asset has been secured, it is requested (356) that a security-code be entered using an input device. Next, movement is received (358) from the input device and an input-code is generated (360) based on the movement. Thereafter, it is determined (362) whether content associated with the digital media asset has been encrypted. Accordingly, the content associated with the digital media asset is decrypted (364) using at least a portion of the input-code which has been generated (360) based on the user movement received (358) from the input device. Thereafter, it is determined (366) whether access to the digital media has been locked. It should be noted that the content is not decrypted if it is determined (362) that the content has not been encrypted, and the method 350 proceeds directly to determine (366) whether access to the digital media asset has been locked. In either case, if it is determined (366) that access to the digital media asset has been locked, the input-code generated (360) based on the movement received (358) from the input device is compared (368) with the security-code used to lock access to the digital media asset. The comparing (368) may, for example, compare one or all of the input-keys which make or collectively represent the input-code with one or more of the security-keys in the security-code (e.g., 34, 12, 11). In any case, based on the comparing (368) of the security-code, it is determined (370) whether to grant access (i.e., unlock the lock placed on access) to the digital media asset. Accordingly, access to the digital media asset could be granted (380) and the method 350 can end. However access may be denied (382) based on the comparing (368) of the input-code with the security-code. If access is denied (382), it is determined (384) whether the security-code may be reentered. If it is determined (384) that the security-code may not be reentered, the method 350 ends. However, if it is determined (384) that the security-code may be reentered, it is requested (356) that a security-code be entered, and the method 350 proceeds in similar manner as discussed above. It should be noted that determination of whether to reenter a security-code (384) can, for example, be made based on a determined number of attempts user can make to enter the correct security-code (e.g., 1, 2, 4, 10, 100, or infinite). As will be appreciated by those skilled in the art, the same input code (360) need not be used for the decrypting the content (364) and unlocking a lock to grant access (380). In general, it is possible to have different security-codes for different security operations (e.g., encryption, locking).

Again, it should be noted that the movement received as input, for example, by the input device 106, can be mapped as movement in, one, two, or three, or more generally n-dimensional virtual space. In accordance with one aspect of the invention, rotational movement associated with user input is mapped into movement or rotation of a virtual circle. For example, user movement provided as input may be considered as left or right rotation (clockwise or counter-clockwise). In addition, a plurality of security-keys (e.g., numbers, icons, letters) can be determined and assigned to a virtual circle which is rotated in response to rotational movement received as input, typically from an input device (e.g., input device 106).

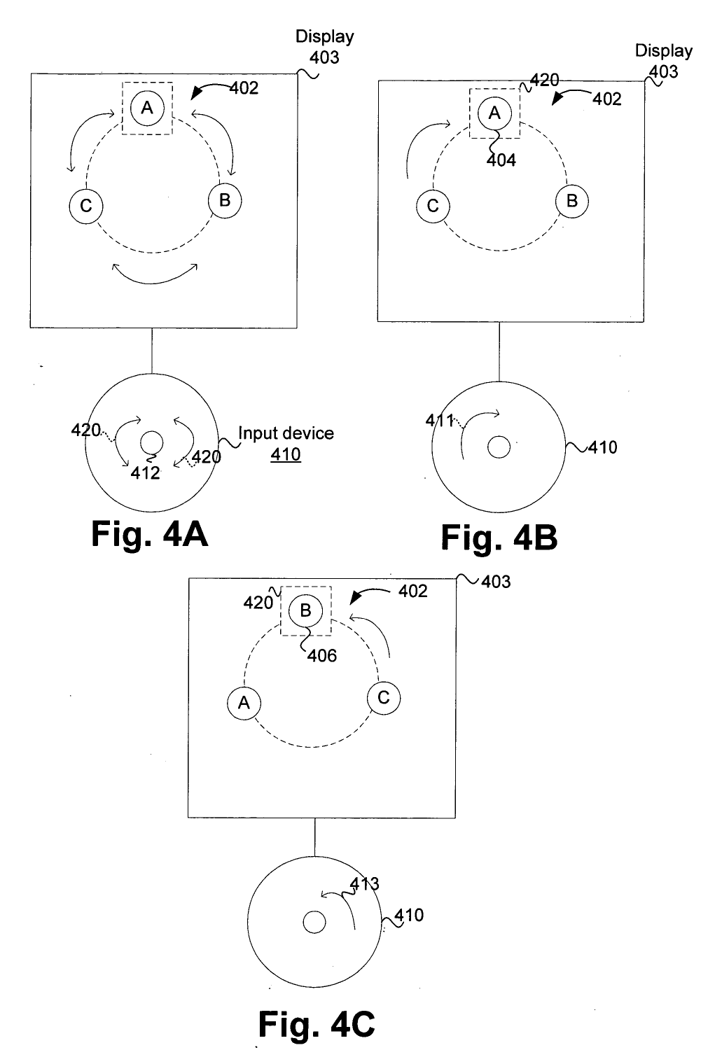

To further elaborate, FIG. 4A depicts a virtual circle 402 with three (3) security-keys denoted as A, B and C. It should be noted that one or all of the security-keys may be displayed on a display 403 at a given time, and the user may rotate the virtual circle 402 by inputting rotational movement 420 into an input device 410 (e.g., left or right rotation). The user may also select a security-key by pressing an input button 412. By way of example, referring now to FIG. 4B, after rotating the virtual circle 402 to the right as a result of inputting right rotational movement 411, the user may select security-code 404 (A) which can be displayed in a designated upper portion 420 of the display 403. Subsequently, as shown in FIG. 4C, the user may apply a left rotation 413 to input device 410 to position the security-key 406 (B) in the designated upper portion 420 of the display 403 (FIG. 4C), and so on. Accordingly, the user may enter rotational movement into the input device 410 to define or enter a security-code which may, for example, be represented as: “→A, ←B” (or rotate right to A, and then rotate left to B). In general, the virtual circle 402 may be divided into a determined number of security-keys, and a security-code may be generated by rotating the virtual circle 402 to the left or right and selecting one or more security-keys that can define a security-code. As will be appreciated, the number of security-keys in a security-code may be a variable which is not publicized. In other words, accessing a digital media asset would additionally require knowing the number of security-keys that make up a security-code, thus further enhancing security without requiring use of additional security-keys.

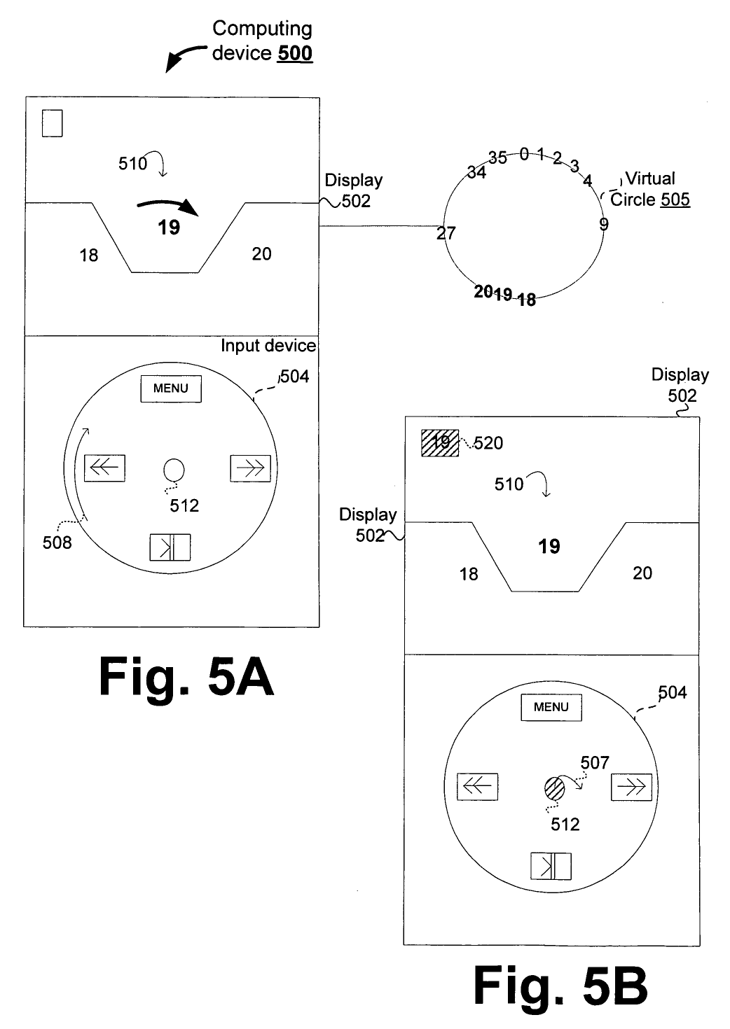

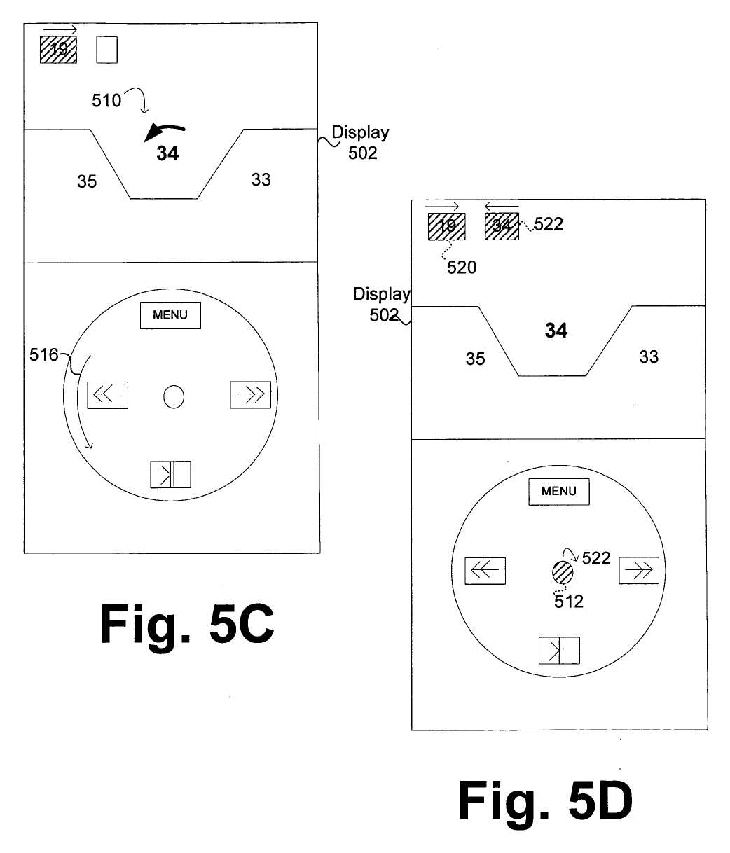

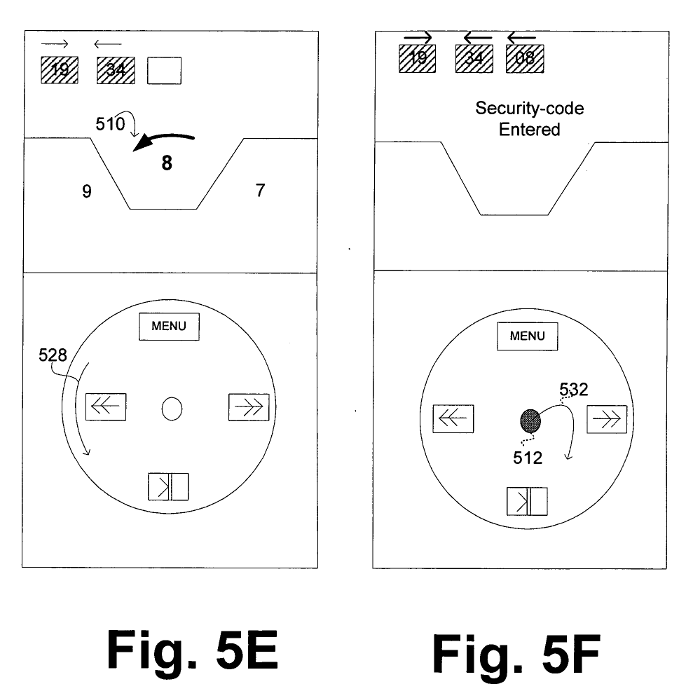

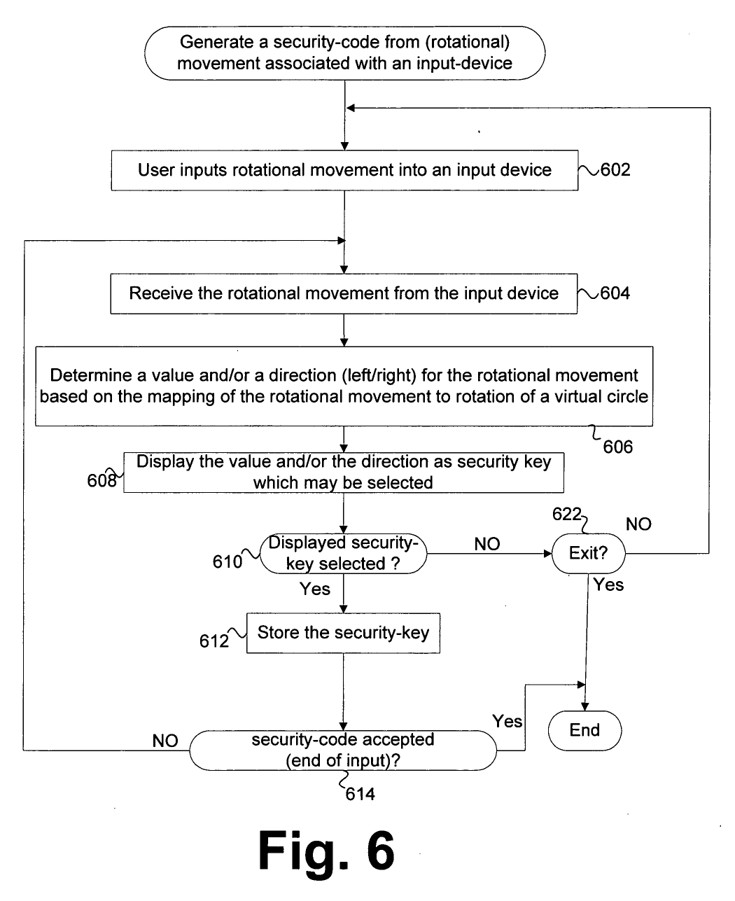

FIG. 5A depicts a computing device 500 in accordance with one embodiment of the invention. The computing device 500 can, for example, be a portable device, wireless phone, digital assistant, a media-player (e.g., an Apple iPod available from Apple Computer, Inc., Cupertino, Calif.). This example demonstrates use of a virtual circle 505 that is divided into thirty-six (36) security-keys, namely, numbers 0-35 placed at an equal distance around the circumferences of the virtual circle 505. However, it will be apparent that a virtual circle may be divided into any desired number of security-keys which may take various forms (e.g., number, icons, letters). In this exemplary embodiment, numbers are used and displayed on the display 502. Furthermore, the display 502 can be updated as rotational movement is applied to the input device 504. By way of example, right rotational movement 508 may be applied as input to rotate the virtual circle 505 clockwise so that number “19” is displayed on a designated top portion 510 of the display 502. The display portion 510 is designated for showing numbers which may be selected as a security-key by pressing a selection-button 512. Referring to FIG. 5B, the security-key displayed on the designated portion 510 of the display 502 “19” may be selected by applying a short-press 507 to a selection-button 512. It should be noted that numbers immediately preceding and following “18” and “20” the selectable number (or security-key) displayed in display portion 510 “19” can also be displayed to provide the user with a better perspective of the virtual circle 505 and the rotational movement affecting its rotation.

Referring now to FIG. 5C, after selecting “19” as a security-key by applying a short-press 507 to the selection-button 512 (FIG. 5B), the user may, for example, start applying a left rotational 516 movement to rotate the virtual circle 505 to eventually display another number “34” in the designated display portion 510 which may be selected as a security-key (FIG. 5C). As shown in FIG. 5C, number “34” may also be displayed on the display portion 510. Referring to FIG. 5D the number “34”may be selected as a security-key by applying a short-press 522 to the selection-button 512 (FIG. 5D). It should be noted that indicators 520 and 522 may also be displayed in upper portion of the display 502 to indicate the security-keys which have been selected by the user (FIG. 5D).

Referring next to FIG. 5E, a left rotational movement 528 may subsequently be input to rotate the virtual circle 505 counter clock-wise until number “8” is displayed in the display portion 510. Finally, referring to FIG. 5F, application of a long-press 532 to the selection-button 512 results in selecting “8” as the third and last security-key in a security-code that can be represented: →19, ←34, ←8 (or right to 19, left to 34, and left to 8).

FIG. 6 depicts a method 600 for generating a security-code based on rotational movement input by a user in accordance with one embodiment of the invention. Initially, a user inputs (602) rotational movement into an input device (e.g., touch-screen, joy-stick, control-pad with direction keys). Next, the rotational movement is received (604) from the input device (e.g., as digital output generated by the input device). Thereafter, a value (e.g., number, icon, letter) and/or a direction (e.g., left or right rotation) is determined (606) based on the rotational movement received (604) from the input device. It should be noted that the value and/or direction are determined (606) based on a mapping of the rotational movement received as input into rotational movement (i.e., rotation) of a virtual circle. Typically, the virtual circle is divided into a plurality of items which represent various security-keys that can be selected. In general, the virtual circle relates a plurality of values in a predefined spatial relationship.

Subsequently, the determined value and/or direction of the rotational movement are displayed (608) as a security-key which may be selected. It should be noted that the security-code may, for example, be selected in the process of entering or defining a security-code. Accordingly, it is determined (610) whether the displayed (608) security-key has been selected as a security-key. If it is determined (610) that the displayed security-key has been selected, the value and/or direction are stored as a security-key (e.g., “36”, “→”, “→36”). Otherwise, it is determined (622) whether to exit the method 600. If it is determined not to exit the method 600, the user inputs (602) rotational movement into the input device and rotational movement is received (604) from the input device. In effect, various security-keys can be determined (606) and displayed (608) based on the rotational movement received (604) until a security-key is selected (610) or the method 600 exits (622). If it is determined (610) that a displayed security-key is selected, the security-key is stored (612). The method 600 proceeds in a similar manner as discussed above until it is determined (614) that a security-code which includes one or more security-keys have been accepted, or it is determined (622) to exit (i.e., terminate) the method 600 prior to accepting a security-code.

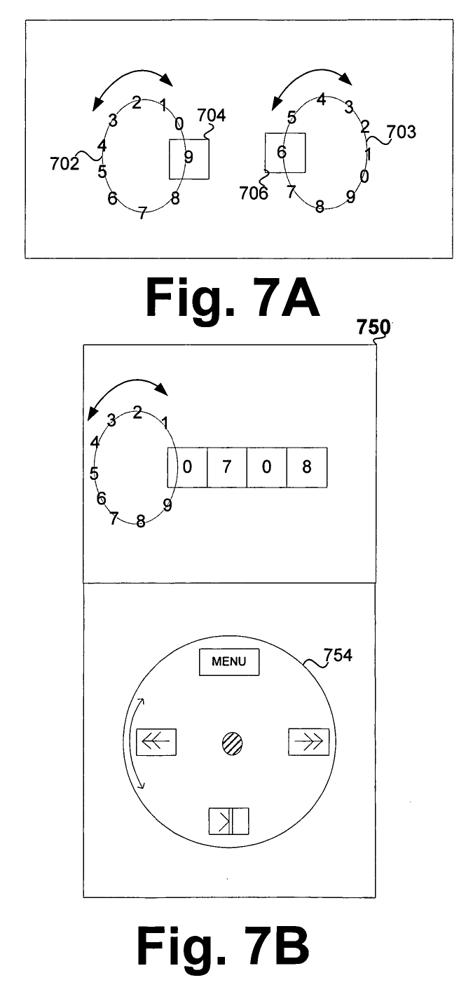

FIG. 7A depicts a plurality of virtual circles 702 and 703 arranged to represent a security code in accordance with one embodiment of the invention. Each of the plurality of virtual circles 702 and 703 is divided into ten (10) security-keys, namely digits (0-9). Similar to the embodiment described above, a plurality of input can be applied to rotate the virtual circles 702 and 703. In addition, a display portion 704 can display a security-key (or digit). The display 702 can be updated as the virtual circle 702 rotates in response to input typically received from a human being. A security code (or digit) can be selected when it is in display. As shown in FIG. 7A, a security-key (or digit) “9” can, for example, be selected. Similarly, a security-key (or digit) “6” can, for example, be selected and displayed in a display portion 706. As will be appreciated, the security-keys can be arranged in sequence to represent a security-code (i.e., the two-digit number 96). It will be appreciated that the security-code can be applied, for example, to lock (or block) access to a device, menu, or an access mechanism used to access a device or to access digital data stored on a device or on a digital medium accessible to the device.

FIG. 7B depicts a computing device 750 in accordance with one embodiment of the invention. The computing device 700 can, for example, be a portable device, wireless phone, digital assistant, a media-player (e.g., an Apple iPod). As shown in FIG. 7B, a security-code can, for example, be represented as a sequence of digits, namely, “0,” “7,” “0,” and “8” (or security-code “0708”). Similar to embodiments described above, rotational movement can be applied to an input device 754 to select the security-code (“0708”). This security-code can, for example, be used to secure access to the computing device 750 itself, menus or an access mechanism for accessing the computing device 750 or accessing digital data stored in or by the computing device 750.

As demonstrated by various embodiments described above, the invention allows users of various computing device to conveniently input a security-code and use it to secure and control access to a device (or data associated with the device) in a manner which resembles using a physical combination-lock with multiple mechanical rotating.

The invention has many advantages. One or more embodiments of the invention may, for example, provide the following advantages. One advantage of the invention is that digital data can be secured based on movement received as input. Another advantage of the invention is that digital data can be secured by simulating the locking mechanism of mechanical devices which are familiar to users. Yet another advantage of the invention is that rotational movement may be conveniently applied, for example, by a single thumb or finger to effectively define or reenter a security-code. Still another advantage of the invention is that security of digital data can be further enhanced without requiring substantially more input from the user by considering the direction of movement input by the user and/or not publicizing the number of security-keys that have to be entered.

The many features and advantages of the present invention are apparent from the written description, and thus, it is intended by the appended claims to cover all such features and advantages of the invention. Further, since numerous modifications and changes will readily occur to those skilled in the art.

What is claimed is:

1. A method of securing digital data, said method comprising:
receiving a plurality of input from an input device, wherein said input device is not a keyboard;
determining a security-code based on said plurality of input; and
securing said digital data by said security-code.

2. A method as recited in claim 1, wherein said digital data is stored as or in a digital media asset.

3. A method as recited in claim 1, wherein said plurality of input is movement input by a user into said input device.

4. A method as recited in claim 1, wherein said security-code comprises one or more security-keys and each of said security-keys includes one or more of the following:
a value, and
a direction associated with direction of said plurality of input.

5. A method as recited in claim 3, wherein said security-code comprises a sequence of one or more security-keys and each of said security-keys includes one or more of the following:
a value, and
a direction associated with direction of said movement.

6. A method as recited in claim 3, wherein said movement is rotational movement.

7. A method as recited in claim 6,
wherein said rotational movement is left or right rotational movement, and
wherein said determining of a security-code comprises: determining at least partly based on said left or right movement one or more security-keys that collectively represent said security-code.

8. A method as recited in claim 7, wherein each of said security-keys includes one or more of the following:
a value, and
a left or right direction associated with the direction of movement to reach said value.

9. A method as recited in claim 8, wherein said value is a number, one or more text characters, or an icon.

10. A method as recited in claim 1, wherein said security-code comprises one or more security-keys.

11. A method as recited in claim 1, wherein securing said digital data comprises one or more of the following:
encrypting content associated with said digital data using at least a portion of said security-code as an encryption key, and
locking access to said digital data using at least a portion of said security-code as a lock.

12. A method as recited in claim 11,
wherein said digital data is stored as or in a digital media asset, and
wherein said digital media asset is a digital file, a list identifying a collection of digital files, a collection of digital files, a digital media-player, a menu, a menu item, or an executable program.

13. A method of securing digital data, said method comprising:
receiving, from an input device, rotational movement input by a user of said input device;
determining a security-code based on said rotational movement; and
securing said digital data by said security-code.

14. A method as recited in claim 13,
wherein said digital data is stored as or in a digital media asset, and
wherein said digital media asset is a digital file, a list identifying a collection of digital files, a collection of digital files, a digital media-player, a menu, a menu item, or an executable program.

15. A method as recited in claim 13, wherein securing said digital media asset comprises one or more of the following:
encrypting content associated with said digital media asset using at least a portion of said security-code as an encryption key, and
locking access to said digital media asset using at least a portion of said security-code as a lock.

16. A method as recited in claim 15,
wherein said rotational movement is left or right rotational movement, and
wherein said determining of a security-code comprises:
mapping said left or right rotational movement to left or right rotation of a virtual circle, wherein said virtual includes a plurality of security-keys which are arranged in a determined spatial relationship with each other.

17. A method as recited in claim 15, wherein each security-key includes one or more of the following:
a value, and
a left or right direction associated with the direction of movement to reach said value.

18. A method as recited in claim 17,
wherein said value is a number, and
wherein said security-code includes one or more numbers.

19. A method as recited in claim 17, wherein said security-code is a sequence of numbers which are separated by left or right direction, thereby representing a combination-lock similar to a mechanical combination-lock.

20. A method as recited in claim 19, further comprising:
displaying one or more security-codes; and
receiving a selection that identifies

21. A device for securing digital data, wherein said device is capable of:
receiving a plurality of input from an input device, wherein said input device is not a keyboard;
determining a security-code based on said plurality of input; and
securing said digital data by said security-code.

22. A device as recited in claim 20, wherein said device includes said input device.

23. A device as recited in claim 21, wherein securing said digital data comprises one or more of the following:
encrypting content associated with said digital data using at least a portion of said security-code as an encryption key, and
locking access to said digital data using at least a portion of said security-code as a lock.

24. A device as recited in claim 22,
wherein said digital data is stored as or in a digital media asset, and
wherein said digital media asset is a digital file, a list identifying a collection of digital files, a collection of digital files, a digital media-player, a menu, a menu item, or an executable program.

25. A device for securing digital data, wherein said device is capable of:
receiving rotational movement input;
determining a security-code based on said rotational movement; and
securing said digital data by said security-code.

26. A device as recited in claim 25, wherein said device is a media-player.

27. A device as recited in claim 24,
wherein said device is a media-player, and
wherein said rotational movement is left or right rotational movement,
wherein said determining of a security-code comprises:
mapping said left or right rotational movement to left or right rotation of a virtual circle, wherein said virtual includes a plurality of security-keys which are arranged in a determined spatial relationship with each other.

28. A portable media-player, comprising:
memory suitable for storing digital data;
an input configured to receive rotational movement input by a user of said media-player;
a display configured to display data; and
at least one processor which can access digital data stored in said memory and determine a security-code based on rotational movement input by said user into said input.

29. A portable media-player as recited in claim 28, wherein said at least one processor is further capable of:
displaying said security-code on said display, and
securing or controlling access to said media-player or digital data based on said security-code.

30. A portable media-player as recited in claim 29, wherein said digital data is a digital file, a list identifying a collection of digital files, a collection of digital files, a menu, a menu item, or an executable program.

31. A portable media-player as recited in claim 28, wherein said determining a security-code based on rotational movement comprises:
determining a security-key based on left or right rotational movement received by said input;
displaying said security-key on said display;
determining whether said security-key has been selected by said user;
determining said security-code based on said security-key when said determining determines that said security-key has been selected.

32. A portable media-player as recited in claim 31, wherein said determining of a security-key based on left or right rotational movement comprises:
left or right rotating a virtual circle which is divided into a plurality of keys, thereby determining a security-key based on the rotational movement input by said user.

33. A portable media-player as recited in claim 30, wherein said security-code is a sequence of numbers which are separated by left or right direction, thereby representing a combination-lock similar to a mechanical combination-lock.

34. A computer readable medium including at least computer program code for securing digital data, said method comprising:
computer program code for determining a security-code based on a plurality of input which is entered into an input device, wherein said input device is capable of receiving movement as input; and
computer program code for securing said digital data by said security-code.

35. A method of controlling access to digital data that has been secured by a security-code, said method comprising:
receiving a plurality of input from an input device, wherein said input device is not a keyboard;
determining an input-code based on said plurality of input; and
controlling access to said secured digital data based on said input code.

36. A method as recited in claim 35, wherein said controlling access comprises one or more of the following:
using said input-code to decrypt said secured digital data; and
comparing at least a potion of said input-code to at least a portion of said security-code.

37. A method as recited in claim 35, wherein said plurality of input include rotational movement input by a human.

38. A method of securing or controlling access to a device that can store digital data, said method comprising:
receiving a plurality of input from an input device, wherein said input device is not a keyboard;
determining a security-code based on said plurality of input; and
securing or controlling access to said device based on said security-code.

39. A method as recited in claim 38,
wherein said device is a media player, and
wherein said plurality of input includes rotational movement.

40. A method as recited in claim 39, wherein said security-code represents a number that includes one or more digits.

41. A device capable of storing digital data, wherein said device is further capable of:
receiving a plurality of input from an input device, wherein said input device is not a keyboard;
determining a security-code based on said plurality of input; and
securing or controlling access to said device or digital data associated with said device based on said security-code.

42. A device as recited in claim 41, wherein said securing or controlling access comprises one or more of the following:
securing access to digital data stored by or in said device;
securing access to, a menu or an access mechanism, for accessing said device or accessing digital data stored by or in said device.
controlling access to digital data stored by or in said device; and
controlling access to a menu or an access mechanism for accessing said device or digital data stored by or in said device.
